(19) United States
(12) Patent Application Publication
(10) Pub. No.: US 2016/0075597 A1
(43) Pub. Date: Mar. 17, 2016

(54) PRODUCING A DISC FROM CERAMIC GLASS

(71) Applicant: SAINT-GOBAIN GLASS FRANCE, Courbevoie (FR)

(72) Inventor: Paul Kirk RATZEL, Pully (CH)

(21) Appl. No.: 14/784,385

(22) PCT Filed: Apr. 14, 2014
(86) PCT No.: PCT/CH2014/000047

§ 371 Date: Oct. 14, 2015

(30) Foreign Application Priority Data
Apr. 17, 2013 (CH) 00 787/13

(51) Int. Cl. C03C 19/00; B24B 19/00

(52) U.S. Cl. CPC C03C 19/00; B24B 19/008

(57) ABSTRACT

A method for manufacturing a ceramic glass pan is put forward, includes providing a green glass pane, mechanically grinding and/or polishing the green glass pane, and ceramising the green glass pane into the ceramic glass pane after grinding and/or polishing. The polishing time and polishing effort can be significantly reduced if the glass is polished before the ceramisation step.

### BACKGROUND OF THE INVENTION

1. Field of the Invention

The present invention generally relates to glass ceramics and, in particular, relates to the manufacture of a pane of ceramic glass.

2. Description of Related Art

Glass ceramics are glass that is manufactured by way of controlled, at least partial crystallisation of base glass (so-called “green glass”). Thereby, aluminosilicate glass, in particular according to the European standard EN 1748-2-1: 2004 is of particular significance.

Base glass is not usually manufactured by way of the float method, as is the case with most commercially available glass panes (i.e., by way of pouring onto a bath of liquid tin). In contrast, base glass is mostly melted and rolled out via rotating rollers. Glass that is created in such a manner is textured on the surface, which is inherent of this drawing process. This results in optical distortions of objects behind the glass when this is used as a transparent construction element (in buildings, transport means etc). The glass “scatters” the light, and objects behind the glass act in a slightly diffuse or hazy manner.

A further process step is necessary in order to manufacture glass ceramic from base glass: the glass is thermally post-treated in a special high-temperature process. Micro-crystallites thereby arise in the glass—the glass “ceramises”. It is not until this ceramised form is present that there result the advantageous characteristics of glass ceramics, in particular a thermal coefficient of expansion which approaches zero. This thermal coefficient of expansion, which is approximately zero, has the effect, for example, that the glass ceramic does not crack or burst with abrupt temperature changes or large temperature gradients, as is the case with other glass. Glass ceramics for this reason are also known as materials for cookware or hotplates as well as viewing windows for ovens of all types.

This characteristic is also advantageous with regard to the application as a construction element. For example, there are countries (including USA), in which the stipulated fire protection tests demand the integrity of the glass even with a rapid cooling (e.g. in so-called “hose stream tests” that simulate an extinguishing procedure by the fire brigade). The glass is not allowed to be destroyed due to thermal stresses, even with a rapid cooling.

The disadvantage with the use as a construction element in building construction and civil engineering or transport means, however, are the optical distortions, which are mentioned above and which are still present also in ceramised glass. The glass even shrinks slightly with the ceramisation procedure (i.e. a small volume contraction results). This further amplifies the effects of the superficial/surface texturing—and the glass becomes even more diffuse. Moreover, it has been found that the problem is difficult to overcome with a polishing procedure. It is only possible to eliminate the surface roughness of ceramic glass by the common mechanical or mechanical/chemical polishing methods with a huge amount of effort.

A method for manufacturing glass ceramic articles with an improved surface is known from DE 10 2006 023 078. This envisages subjecting a green glass pane manufactured by hot forming to a heat treatment on the surface (a so-called fire polishing), before or during the ceramisation. Thereby, with the cooling subsequent to the hot forming, one must take care that this treatment is effected before reaching a temperature at which nucleation arises, since a hazing of the glass ceramic otherwise results.

The disadvantage with this method is the circumstance that the surface treatment must be effected very promptly to the hot forming of the green glass, as well as the difficult controllability of the process.

### SUMMARY OF THE INVENTION

It is the object of the present invention, to provide a method for manufacturing a ceramic glass component, in particular a ceramic glass plane, which overcomes the disadvantages of the state of the art and which in particular eliminates the surface texturing with an acceptable effort.

The invention is based on the very surprising recognition that on the one hand a green glass pane (i.e. a pane of base glass that can be ceramised into glass ceramic) can be mechanically ground and/or polished with a moderate amount of effort, such that a surface texturing compromising the optical perception is no longer present, i.e. that objects behind the pane no longer act in a diffuse manner. On the other hand, it is also based on the recognition that the positive surface characteristics are retained after such a mechanical grinding/polishing process with the subsequent ceramisation, i.e. the finished ceramic glass is neither hazy nor diffuse.

Moreover, it was also likewise surprisingly ascertained that no reduction of the mechanical loadability with regard to the end product results from the surface treatment by way of grinding and/or polishing the green glass results.

Methods, in which the glass surface is abraded and/or smoothed in a purely mechanical manner, or in which this is effected mechanically with chemical assistance, for example by way of admixing a component reacting with the glass surface, to a grinding or polishing means/agent, are indicated here as a mechanical grinding or polishing. Particularly preferably, the treatment is accomplished by way of purely mechanical processes, for example with diamond tools (grinding) or with polishing means (e.g. cerium oxides, aluminium oxides (e.g. corundum), iron oxides etc.).

The process of the grinding and/or the polishing according to a first option can, for example comprise the uppermost layers firstly being mechanically abraded, for example by way of a diamond tool, and the surface being subsequently mechanically polished, for example by way of a paste with a diamond oxide, cerium oxide, aluminium oxide, iron oxide and/or other suitable particles. According to a second option, the process only comprises a corresponding polishing process, with which no significant quantities of glass are abraded. The implementation of only a grinding process is basically also conceivable, inasmuch as the resulting surface roughness is sufficiently small for the aspired purposes.

The surface roughness is reduced on polishing. The polishing of a surface is therefore to be seen as counter or opposite to a roughing of the surface.

The grinding and/or polishing of the green glass pane relate to at least a part of the surface. Two opposite, large areas of the surface can be ground and/or polished, for example. Such a treatment (machining) is mostly not necessary at the edges, but however is also not ruled out. It can also be sufficient, depending on the application, for this grinding and/or polishing to only be effected at one side and/or only in regions, for example if the remaining rough surface is covered with immersing media (e.g. shatter-protection foils/films etc.).

The manufacture of a ceramic glass pane can therefore firstly comprise the manufacture of the green glass pane of a suitable glass mass (for example, of an aluminosilicate mass) and the machining by way of grinding and/or polishing, which is effected immediately afterwards, wherein the green glass pane is preferably firstly cooled, for example to a temperature of 200° C. at the most, after the hot forming.

The manufacture of the green glass pane by way of hot forming, for example the rolling out in a molten condition between rotating rollers can be effected therein.

The method that is taught here is also very well suited for embodiments in which the green glass pane is not manufactured at the same location at which the surface machining/treatment also takes place, and the surface treatment with regard to time is also independent of the forming of the green glass pane, due to the fact that this method however demands no increased temperature of the green glass pane with its surface treatment, and cooling to room temperature before the surface treatment is not a problem. For example, relatively much time can pass (e.g. at least 2 hours, but also days or weeks) without disadvantages arising, depending on the existing manufacturing conditions, storage conditions and transport conditions.

The subsequent ceramisation (“firing”) can be effected independently of the surface treatment with regard to time and/or location. This permits a flexible production, which is optimised by considering existing circumstances and capacities, without additional energy having to be consumed for an intermediate heating step.

Even if the method is particularly advantageous for ceramic glass panes, which are manufactured by hot forming, it is however also suitable for differently manufactured green glass panes, for example per se also for panes manufactured in the float method.

The green glass can be an aluminosilicate glass, in particular according to the European standard EN 1748-2-1.

The green glass pane is generally of such a nature that it is transparent and for example clear, i.e. not hazy, after the ceramisation—this can be carried out in a furnace that is common for such purposes, e.g. in a batch process or a continuous process.

Further mechanical machining/processing steps such as cutting to size, the treatment of edges etc. can take place before or after the grinding and/or polishing and before or after the ceramisation.

A further processing can take place subsequently to the ceramisation, for example the coating, the fitting into a frame, the joining-together with further panes and/or other layers into a composite glass pane, and/or other processes, as are known per se for transparent panes.

The method according to the invention is particularly favourable in the context of manufacture of the green glass pane by hot forming, in particular by mechanical deformation of the melted green glass, for example by way of rotating rollers.

The invention also relates to the use of a ceramic glass pane that is manufactured with the method according to the invention—on its own or as part as a composite—as a transparent glass pane of a building or transport means (vehicle, ship, plane). The ceramic glass pane for such an application, subsequent to the ceramisation and, as the case may be, further processing steps is assembled in a suitable manner as part of a building or transport means.

### BRIEF DESCRIPTION OF THE DRAWINGS

Features and embodiments of the invention are hereinafter discussed by way of schematic figures. In the figures, the same reference numerals indicate the same or analogous elements. There are shown in:

FIG. 1 a process of green glass pane forming;

FIG. 2 a grinding process; and

FIG. 3 a polishing process; and

FIG. 4 a ceramisation process.

### DETAILED DESCRIPTION OF THE INVENTION

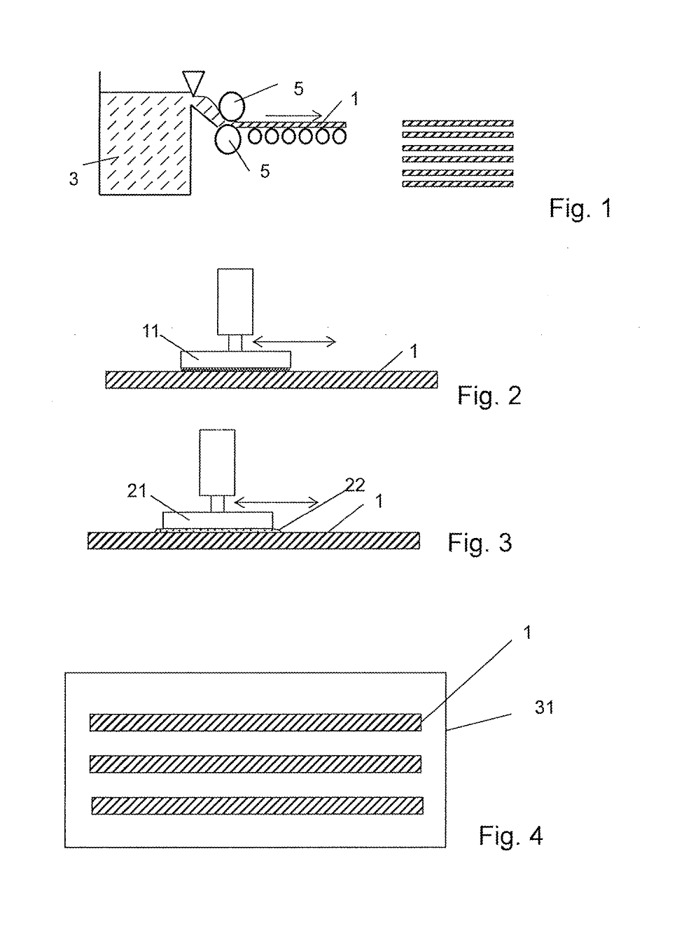

The step of hot forming green glass panes 1 of a glass melt 3 and which is represented FIG. 1 can optionally be a part of the method according to the invention. The method according to the invention can alternatively also be carried out with premanufactured, e.g. also commercially obtainable green glass panes.

The green glass panes 1 in the process are formed by rolling out between two rotating rollers 5. In the shown example, this is accomplished in a continuous process, wherein the arising “drawn” green glass pane, for example, is cut at regular distances, so that one obtains a plurality of discrete green glass panes 1. These can be cooled passively or in an accelerated manner by way of active means (ventilation, cooling on contact with a cooler, etc.) and if necessary stored transported and/or processed.

FIG. 2 shows the grinding of one of the green glass panes 1, for example by way of a rotating diamond tool 11 that is moved relative to the pane along the surface. The glass material of the uppermost layers is abraded on grinding. The grinding process is drawn in the figure for one of the two large surfaces. A grinding process can, however, also be effected for both of the large surfaces, either simultaneously or sequentially, wherein the glass pane can be turned between the grinding procedures for the two surfaces in the latter case.

FIG. 3 in a very schematic manner as is the case for all figures, shows a polishing process. Such a polishing process can be carried out subsequently to a grinding process (FIG. 2) or also on its own—without a prior grinding process. The opposite (only grinding without polishing) is also conceivable in principle, inasmuch as the resulting surface roughness is sufficiently small for the desired purposes.

A polishing process can also be carried out in a manner known per se. FIG. 3 shows a polishing device with a rotating polishing pad 21 and a suitable paste 22 between the pad 21 and the glass surface. The polishing device is moved relative to the surface for polishing. As with all relative movements described here, this can also be effected by way of moving the glass pane in the case of a stationary active means (here the polishing device) or by way of moving the glass pane as well as the active means (for example, moving the glass pane in a conveying direction, combined with movements of the active means along the surface, said movements being transversal to this conveying direction).

The polishing is effected until a desired surface texture is achieved.

A polishing can also be carried out on both opposite glass surfaces, either simultaneously or one after the other and a turning of the glass pane 1 between the polishing procedures is likewise possible.

FIG. 4 schematically shows a high-temperature furnace 31, in which the green glass panes 1 are fired into ceramic glass panes. This is effected under the conditions known per se for the manufacture of glass ceramic—for example according to the standard EN 1748-2-1 and with the respective operating parameters which are necessary for the ceramisation.

It has been found that the ceramisation no longer alters the smooth surfaces, which are achieved in the grinding and/or polishing process.

Alternatively to that which has been described above, the procedures shown in FIGS. 1 and 2/3 can also be carried out one after the other in a continuous method, i.e. an endless glass pane that arises on hot forming (FIG. 1), after it has cooled somewhat, is ground and/or polished on one or both of the large surfaces and only then—or even not until after the ceramisation in the furnace—separated into discrete glass panes.

Inasmuch as the glass panes are ground as well as polished, the processes according to FIGS. 2 and 3 can optionally take place in a directly successive manner in the same installation.

The processes of FIGS. 2/3 on the one hand and 4 on the other hand can also be combined, for example by way of the glass panes or an endless glass pane being fed past the grinding/polishing device, to the firing furnace 31 and thus being fired directly after the surface treatment.

A cleaning step (not shown) can yet be effected after the grinding/polishing step and before the firing, in order to free the surface from residues of the grinding/polishing means.

1. A method for manufacturing a ceramic glass pane, comprising the steps of:
providing a green glass pane,
mechanically grinding and/or polishing the green glass pane,
ceramising the green glass pane into the ceramic glass pane, subsequently to the step of grinding and/or polishing.

2. The method according to claim 1, characterised in that the green glass pane is manufactured by way of hot forming.

3. The method according to claim 2, characterised in that the green glass pane is manufactured by way of melting and rolling out through rotating rollers.

4. The method according to claim 2, wherein between the manufacture of the green glass pane and the grinding and/or polishing, the glass is cooled to such an extent that it the glass is no longer mechanically deformable.

5. The method according to claim 1, wherein the green glass pane during the mechanical grinding and/or polishing has a temperature of less than 200° C.

6. The method according to claim 1, wherein the mechanical grinding and/or polishing comprises a first part-step, in which material is abraded from the surface with a grinding process and a second part step, in which a surface polishing takes place.

7. The method according to claim 1, wherein the green glass is an aluminosilicate glass.

8. The method according to claim 1, wherein the ceramic glass is transparent and clear.

9. The method according to claim 1, wherein the ceramisation includes bringing the green glass pane to a temperature of above 800° C.

10. The use of a ceramic glass pane which is manufactured according to claim 1, as a transparent glass pane of a building or transport means.

11. The method according to claim 3, wherein between the manufacture of the green glass pane and the grinding and/or polishing, the glass is cooled to such an extent that the glass is no longer mechanically deformable.
